(19) United States
(12) Patent Application Publication
(10) Pub. No.: US 2023/0195075 A1
(43) Pub. Date: Jun. 22, 2023

(54) INFORMATION EXTRACTION APPARATUS, INFORMATION EXTRACTION METHOD, AND STORAGE MEDIUM

(71) Applicant: KABUSHIKI KAISHA TOSHIBA, Tokyo (JP)

(72) Inventors: Masahiro ITO, Tokyo (JP); Tomohiro YAMASAKI, Tokyo (JP)

(73) Assignee: KABUSHIKI KAISHA TOSHIBA, Tokyo (JP)

(21) Appl. No.: 17/823,552

(22) Filed: Aug. 31, 2022

(30) Foreign Application Priority Data
Dec. 16, 2021 (JP) 2021-204276

(51) Int. Cl. G05B 19/406

(52) U.S. Cl. CPC G05B 19/406; G05B 2219/31356

(57) ABSTRACT

According to one embodiment, an information extraction apparatus includes a processor including hardware. The processor extracts a description of a problematic event from text data. The processor extracts, from the text data, a description of a candidate action for taking an action against the problematic event. The processor discerns an effect of the candidate action against the problematic event.

### CROSS-REFERENCE TO RELATED APPLICATIONS

This application is based upon and claims the benefit of priority from Japanese Patent Application No. 2021-204276, filed Dec. 16, 2021, the entire contents of which are incorporated herein by reference.

### FIELD

Embodiments described herein relate generally to an information extraction apparatus, an information extraction method, and a storage medium.

### BACKGROUND

A technique has been proposed for supporting a design to which a change has been made such as a change of a material for manufacturing equipment to another material by storing improvements and adverse effects caused by such a design change in a database and presenting the improvements and adverse effects caused by the design change to a designer based on the database.

In order to take prompt action upon occurrence of a problem during manufacturing of equipment or operation of a device, it is important to list candidate actions that are effective against the problem. Accordingly, a system for collecting candidate actions against a problematic event from texts such as written reports relating to the past problems, and presenting candidate actions against the problematic event that has occurred is considered important. Actions written in the texts such as written reports may include both “ineffective actions” that were actually taken but had no effects on the problematic event and “effective actions” that actually had effects on the problematic event. One might think that only the “effective actions” should be collected; however, the “ineffective actions” may not necessarily be ineffective on other similar problematic events. This is because causes of occurrence of similar problematic events are not necessarily the same. Accordingly, a candidate action for a problematic event listed by a technician is highly likely to be a useful candidate action.

### BRIEF DESCRIPTION OF THE DRAWINGS

FIG. 1 is a block diagram showing an example of an information extraction apparatus according to a first embodiment.

FIG. 2 is a diagram showing an example of text data of a document.

FIG. 3 is a diagram showing an example of extraction result data.

FIG. 4 is a diagram showing an example of a hardware configuration of an information extraction apparatus.

FIG. 5 is a flowchart showing processing of an information extraction program of the information extraction apparatus.

FIG. 6 is a diagram showing a display example of candidate actions against a problematic event.

FIG. 7 is a diagram showing a display example of candidate actions against a problematic event.

FIG. 8 is a diagram showing a display example of candidate actions against a problematic event.

FIG. 9 is a block diagram showing an example of an information extraction apparatus according to a second embodiment.

### DETAILED DESCRIPTION

In general, according to one embodiment, an information extraction apparatus includes a processor including hardware. The processor extracts a description of a problematic event from text data. The processor extracts, from the text data, a description of a candidate action for taking an action against the problematic event. The processor discerns an effect of the candidate action against the problematic event.

Hereinafter, embodiments will be described with reference to the accompanying drawings.

### First Embodiment

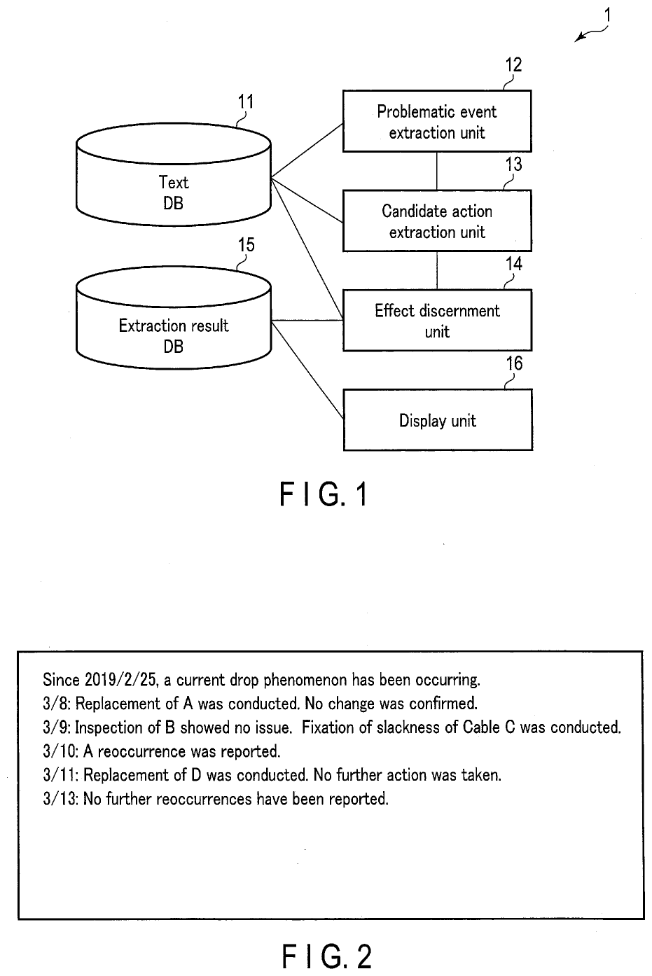

A first embodiment will be described. FIG. 1 is a block diagram showing an example of an information extraction apparatus according to a first embodiment. An information extraction apparatus 1 includes a text database (DB) 11, a problematic event extraction unit 12, a candidate action extraction unit 13, an effect discernment unit 14, an extraction result database (DB) 15, and a display unit 16.

The text DB 11 stores text data of a plurality of documents, such as written reports and daily recordings on a problematic event. FIG. 2 is a diagram showing an example of text data of a document. A document in the embodiments includes at least a description of a “problematic event” and a “candidate action”, and may also include a description of an “effect”. The “problematic event” is a description indicating details of a problematic event which is included in the document and against which an action should be taken. The “candidate action” is a description indicating a candidate for an action that may be taken against the problematic event. Such a candidate action may be an actually taken action, an action planned to be taken, or an action that is yet to be taken but is listed as a possible action. The “effect” is a description indicating whether or not each of the actions that have been taken was effective or ineffective against the problematic event. It is more preferable that descriptions in a document in each embodiment be given in such a manner that the time series of the details can be specified. It is desirable, for example, that such details are described with the dates, as shown in FIG. 2 or that such details are described in a time-series manner. By describing the details in a time-series manner, the order of candidate actions, for example, can be easily extracted.

The problematic event extraction unit 12 extracts, from text data of a document stored in the text DB 11, a description of a problematic event. When, for example, text data in the example of FIG. 2 is input, the problematic event extraction unit 12 extracts “current drop” as a description of a problematic event. Example methods of extracting a description of a problematic event include a method of extraction based on a manual input by a user who has checked the document, and a method of extraction through an input of text data to an extraction model subjected to machine learning such as sequence labeling.

The candidate action extraction unit 13 extracts, from text data stored in the text DB 11, descriptions of candidate actions against the problematic event extracted by the problematic event extraction unit 12. When, for example, the text data in the example of FIG. 2 is input, the candidate action extraction unit 13 extracts “replacement of A”, “fixation of slackness of Cable C”, and “replacement of D” as descriptions of candidate actions for the problematic event “current drop”. Example methods of extracting a description of a candidate action include an extraction method based on a manual input by a user who has checked the document, and an extraction method through an input of text data to an extraction model subjected to machine learning such as sequence labeling. Moreover, the candidate action extraction unit 13 may extract a description of a candidate action that also contains data on the problematic event. In response to, for example, an input of data on the problematic event extracted by the problematic event extraction unit 12, the candidate action extraction unit 13 may extract candidate actions for the data on the problematic event extracted by the problematic event extraction unit 12.

The effect discernment unit 14 discerns the effects of the respective candidate actions extracted by the candidate action extraction unit 13 for the problematic event extracted by the problematic event extraction unit 12. The effect discernment unit 14 stores the extracted problematic event, candidate actions, and effects in an extraction result DB 15 in association with one another. In the example of FIG. 2, since “no change” is stated as a result of the candidate action “replacement of A”, the effect discernment unit 14 discerns that the effect of the candidate action “replacement of A” is “ineffective”. Similarly, in FIG. 2, since “reoccurrence was reported” is stated on the next day for “fixation of slackness of Cable C”, the effect discernment unit 14 discerns that the candidate action “fixation of slackness of Cable C” is “ineffective”. In FIG. 2, “No further reoccurrences have been reported” is stated at a later date for “replacement of D”. This can be construed to mean that the candidate action “replacement of D” was effective against the problematic event. Therefore, the effect discernment unit 14 discerns that the candidate action “replacement of D” is “effective”. Example methods of discerning an effect include a method of discernment based on a manual input by a user who has checked the document, and a method of discernment through an input of text data, data on a problematic event, and data on candidate actions to a discernment model subjected to machine learning such as sequence labeling. Furthermore, the effect discernment unit 14 may discern an effect based on both data on a problematic event and data on candidate actions. In response to, for example, an input of data on a problematic event extracted by the problematic event extraction unit 12 and data on candidate actions extracted by the candidate action extraction unit 13, the effect discernment unit 14 may discern effects of the respective candidate actions extracted by the candidate action extraction unit 13 for the data on the problematic event extracted by the problematic event extraction unit 12.

It is to be noted that more than one actions may be needed to produce an effect. Thus, the effect discernment unit 14 may associate an effect with a combination of two or more candidate actions. For example, if a document states that “Fixation of slackness of Cable C and replacement of D resulted in solving the problem”, the problem is considered to have been solved only when “fixation of slackness of Cable C” and “replacement of D” were performed at the same time. In such a case, the effect discernment unit 14 may discern that the combination of the candidate action “fixation of slackness of Cable C” and the candidate action “replacement of D” is “effective”. Such discernment may be performed by a method based on a manual input or a method based on a machine training model. In the example shown herein, it is discerned that a combination is “effective”; however, there may be a case where it is discerned that a combination is “ineffective”, as a matter of course.

Moreover, there may be a case where an effect is produced only when two or more candidate actions are taken in a specific order. For example, if a document states that “Reactivation of C and subsequent replacement of B did not solve the issue, but replacement of B and subsequent reactivation of C solved the issue”, it can be construed that the problem has been solved by performing the two candidate actions “replacement of B” and “reactivation of C” in this order. In such a case, the effect discernment unit 14 may discern that an effect of a combination of the candidate action “replacement of B” and the candidate action “reactivation of C” in this order is “effective”. Such discernment may be performed by a method based on a manual input or a method based on a machine training model. In the example shown herein, it is discerned that a combination including the order is “effective”; however, there may be a case where it is discerned that a combination is “ineffective”, as a matter of course.

Hereinafter, a plurality of candidate actions against a problematic event in a document is stated as a “candidate action set” against the problematic event. A candidate action set may be configured of separate candidate actions against a problematic event, may be a combination of a plurality of candidate actions against a problematic event, or may be a combination of candidate actions against a problematic event including its order.

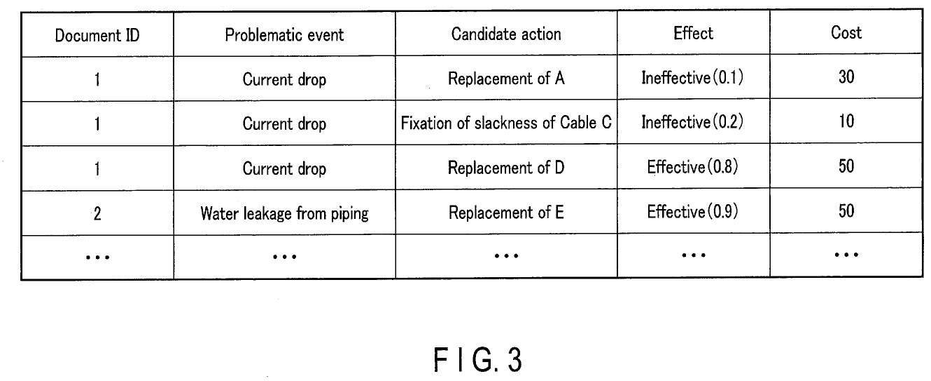

The extraction result DB 15 stores, as extraction result data, data on a problematic event, data on one or more candidate actions, and data on effects associated by the effect discernment unit 14. FIG. 3 is a diagram showing an example of extraction result data. The extraction result data is managed by, for example, a document ID. The document ID is, for example, an identification number uniquely assigned to each document. In each document ID, data on a problematic event, data on candidate actions, and data on effects are associated with one another. Assigning an identical document ID to items of extraction result data means that they have been extracted from an identical document. The data on effects may be expressed with two values respectively representing “effective” and “ineffective”. The data on effects may be expressed with probability values indicating effectiveness or ineffectiveness. The probability value may be, for example, a confidence score of extraction processing based on machine learning, or may be given manually. The extraction result data may further include cost values indicating the costs involved in taking the respective candidate actions. The cost value may be calculated based on the prices of replacement parts, the number of steps, etc., or may be manually given. For determination of the display order in view of the effects and costs to be discussed later, the cost values may be standardized in the range of 0 to 1, similarly to the probability values indicating the effects.

Based on the extraction result data stored in the extraction result DB 15, the display unit 16 displays candidate actions against a problematic event designated by the user on a display.

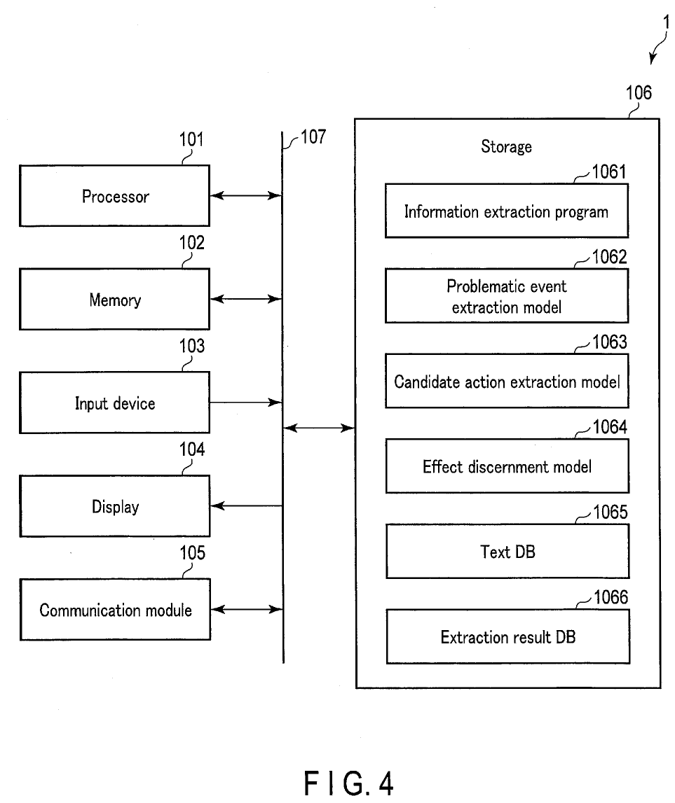

FIG. 4 is a diagram showing an example of a hardware configuration of the information extraction apparatus 1. The information extraction apparatus 1 is a computer, and includes, for example, a processor 101, a memory 102, an input device 103, a display 104, a communication module 105, and a storage 106 as hardware. The processor 101, the memory 102, the input device 103, the display 104, the communication module 105, and the storage 106 are coupled to a bus 107.

The processor 101 is a processor that controls the overall operation of the information extraction apparatus 1. The processor 101 operates as a problematic event extraction unit 12, a candidate action extraction unit 13, an effect discernment unit 14, and a display unit 16 by, for example, executing a program stored in the storage 106. The processor 101 is, for example, a CPU. The processor 101 may be, for example, an MPU, a GPU, an ASIC, an FPGA, etc. The processor 101 may be, for example, either a single CPU or a plurality of CPUs.

The memory 102 includes a ROM and a RAM. The ROM is a non-volatile memory. The ROM stores an activation program, etc. of the information extraction apparatus 1. The RAM is a volatile memory. The RAM is employed as, for example, a working memory during the processing at the processor 101.

The input device 103 is an input device such as a touch panel, a keyboard, a mouse, etc. When an operation is performed via the input device 103, a signal corresponding to details of the operation is input via the bus 107 to the processor 101. The processor 101 performs various processes in response to this signal. The input device 103 is employed for, for example, extraction of a problematic event, extraction of candidate actions, and a user input during discernment of effects described above.

The display 104 is a display such as a liquid crystal display, an organic EL display, etc.

The communication module 105 is a communication device for allowing the information extraction apparatus 1 to communicate with external equipment. The communication module 105 may be a communication device for wired communications, or may be a communication device for wireless communications.

The storage 106 is, for example, a storage such as a hard disk drive or a solid-state drive. The storage 106 stores various programs executed by the processor 101, such as an information extraction program 1061.

The storage 106 may store a problematic event extraction model 1062, a candidate action extraction model 1063, and an effect discernment model 1064. The problematic event extraction model 1062 is a trained model subjected to machine learning such as sequence labeling to extract a description relating to a problematic event from text data of an input document. The candidate action extraction model 1063 is a trained model subjected to machine learning such as sequence labeling to extract a description relating to candidate actions against a problematic event from text data of an input document. The effect discernment model 1064 is a trained model subjected to machine learning such as sequence labeling to discern effects of the respective candidate actions for a problematic event from text data of an input document. As described above, extraction of a problematic event, extraction of candidate actions, and discernment of effects may be performed through a manual input by a user. When the extraction of a problematic event, the extraction of candidate actions, and the discernment of effects are also performed by a manual input by a user, the problematic event extraction model 1062, the candidate action extraction model 1063, and the effect discernment model 1064 may be omitted. The problematic event extraction model 1062, the candidate action extraction model 1063, and the effect discernment model 1064 may not necessarily be stored in the storage 106. For example, the problematic event extraction model 1062, the candidate action extraction model 1063, and the effect discernment model 1064 may be stored in, for example, a server capable of communicating with the information extraction apparatus 1.

The storage 106 may store text database (DB) 1065 and an extraction result database (DB) 1066. The text DB 1065 corresponds to the text DB 14. The extraction result DB 1066 corresponds to the extraction result DB 15. The text DB 1065 and the extraction result DB 1066 may not necessarily be stored in the storage 106. For example, the text DB 1065 and the extraction result DB 1066 may be stored in a server capable of communicating with the information extraction apparatus 1.

The bus 107 is a data transfer path for exchanging data with the processor 101, the memory 102, the input device 103, the display 104, the communication module 105, and the storage 106.

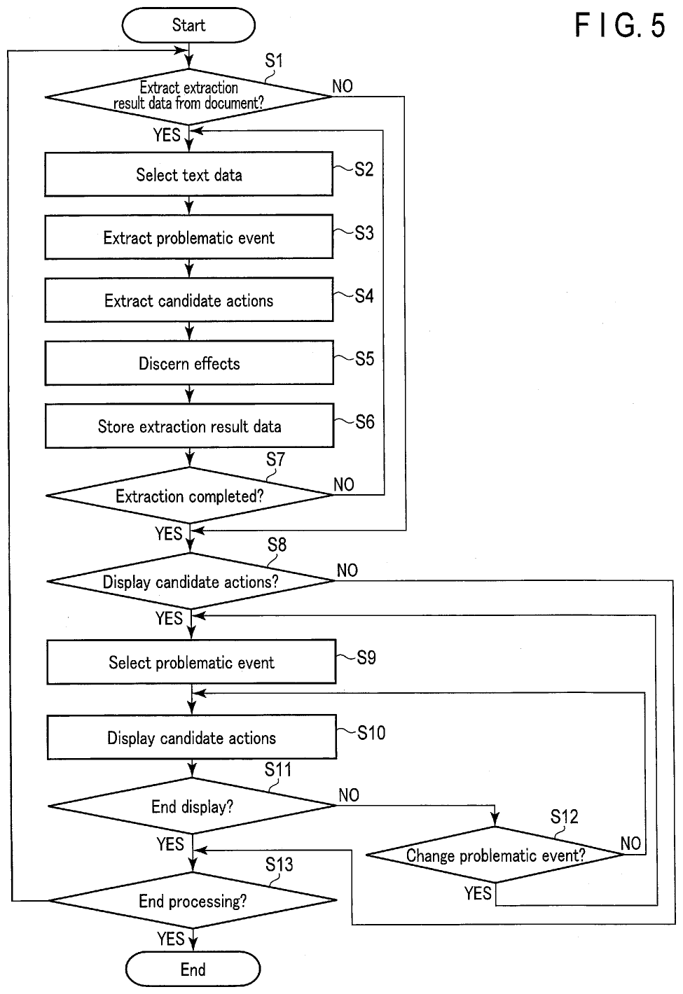

Next, an operation of the information extraction apparatus 1 will be described. FIG. 5 is a flowchart showing processing of the information extraction program 1061 of the information extraction apparatus 1. The processing of FIG. 5 is executed by the processor 101.

At step S1, the processor 101 evaluates whether or not to extract extraction result data from text data of a document. For example, when text data of a new document is input to the information extraction apparatus 1, or when extraction of extraction result data is instructed by a user operation on the input device 103, it is evaluated that the extraction result data is to be extracted from the text data of the document. When it is evaluated at step S1 that the extraction result data is to be extracted from the text data of the document, the processing advances to step S2. When it is evaluated at step S1 that the extraction result data is not to be extracted from the text data of the document, the processing advances to step S8.

At step S2, the processor 101 selects text data. When text data of a new document is input, the processor 101 selects the text data of the new document. On the other hand, when extraction of extraction result data is instructed by the user, the processor 101 selects text data based on a user operation on the input device 103 from the text DB 1065. After selection of the text data, the processing advances to step S3.

At step S3, the processor 101 extracts a description of a problematic event from the selected text data. The processor 101 extracts a description of a problematic event by inputting text data to the problematic event extraction model 1062. Alternatively, the processor 101 displays a text of a document on the display 104. Of the text displayed on the display 104, the processor 101 extracts a description portion designated by a user operation on the input device 103 as a description of a problematic event. After extraction of the description of the problematic event, the processing advances to step S4.

At step S4, the processor 101 extracts, from the selected text data, descriptions of candidate actions corresponding to the description of the problematic event extracted at step S3. The processor 101 extracts descriptions of candidate actions by inputting text data to the candidate action extraction model 1063. Alternatively, the processor 101 displays a text of a document on the display 104. Of the text displayed on the display 104, the processor 101 extracts description portions designated by a user operation on the input device 103 as candidate actions. After extracting candidate actions, the processing advances to step S5.

At step S5, the processor 101 discerns effects against the problematic event corresponding to the candidate actions extracted at step S4 from the selected text data. The processor 101 discerns the effects by inputting the text data to the effect discernment model 1064. Alternatively, the processor 101 displays a text of a document on the display 104. Of the text displayed on the display 104, the processor 101 extracts portions designated by a user operation on the input device 103 as descriptions of effects, and discerns the effects from the extracted descriptions. Alternatively, the processor 101 discerns effectiveness/ineffectiveness based on a user operation on the input device 103. For example, the user designates whether each candidate action is effective or ineffective. Alternatively, the user designates a probability value indicating the effect of each candidate action. When the effectiveness/ineffectiveness or a probability value is designated by a user, a text may not necessarily be displayed. Also, the user may evaluate an effect based on, for example, his or her own expertise, experiences, etc. Various types of statistical information may be employed for discernment of effects. Discernment of effects based on statistical information may be performed by the processor 101 or may be performed by the user. After the discernment of effects, the processing advances to step S6.

At step S6, the processor 101 generates extraction result data containing a problematic event, candidate actions, and effects. The processor 101 appends a document ID to the extraction result data. Thereafter, the processor 101 stores the extraction result data to which the document ID is appended in the extraction result DB 1066.

At step S7, the processor 101 evaluates whether or not extraction has been completed. For example, the processor 101 displays a confirmation screen indicating whether or not extraction has been completed. On the confirmation screen, when the user has selected completion of extraction, it is evaluated that the extraction has been completed. When it is evaluated at step S7 that the extraction has been completed, the processing advances to step S8. When it is evaluated at step S7 that the extraction has not been completed, the processing reverts to step S2. In this case, processing of selection of next text data and the subsequent processing are performed.

At step S8, the processor 101 evaluates whether or not candidate actions against a problematic event are to be displayed. When, for example, display of candidate actions is instructed by a user operation on the input device 103, it is evaluated that candidate actions against a problematic event are to be displayed. When it is evaluated at step S8 that candidate actions against a problematic event are to be displayed, the processing advances to step S9. When it is evaluated at step S8 that candidate actions against a problematic event are not to be displayed, the processing advances to step S13.

At step S9, the processor 101 selects at least one problematic event from among a plurality of problematic events stored in the extraction result DB 1066. The processor 101 displays, for example, a list of documents such as written reports or a list of problematic events on the display 104. The user selects, from the list, a problematic event which the user wishes to know how to take an action against, or a document including such a problematic event. In response thereto, the processor 101 selects a problematic event. Alternatively, the user inputs a keyword associated with a problematic event or details of a problematic event that has occurred. Based on the details input by the user, the processor 101 selects a problematic event. When, for example, an input of “current fall” has been made as a problematic event that has occurred, the processor 101 searches for similar problematic events such as “current dropping”, “current falling”, and “current decreasing” from the extraction result DB 1066. As a method for searching for similar problematic events, a method of taking into consideration synonyms, a method of evaluating similarity in meaning based on machine learning, etc. may be employed. It can be easily assumed that the same or similar problematic events have occurred multiple times. In this case, a plurality of problematic events may be selected for the problematic event designated by the user.

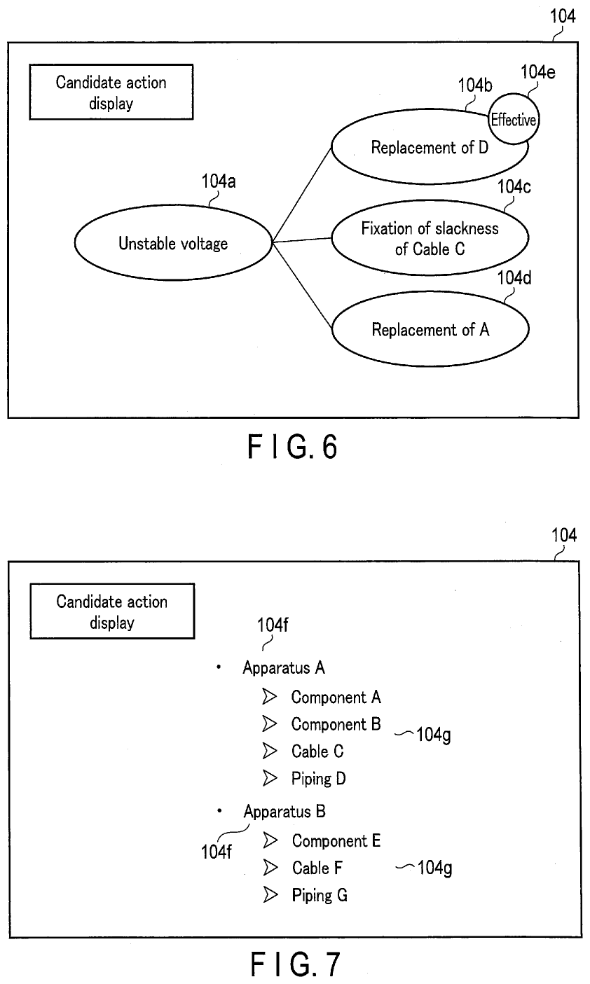

At step S10, based on the extraction result data, the processor 101 displays candidate actions against the selected problematic event on the display 104. FIG. 6 shows a display example of candidate actions against a problematic event. The display example of FIG. 6 shows a case where the problematic event “unstable voltage” has been selected. In FIG. 3, since the problematic event “unstable voltage” corresponds to a problematic event in document ID1, display is performed based on the extraction result data of document ID1 in FIG. 6.

As shown in FIG. 6, in the display of the candidate actions against the problematic event, the selected problematic event 104a is displayed, and a list of candidate actions against the problematic event 104a is displayed. In FIG. 6, three candidate actions 104b, 104c, and 104d are displayed for the problematic event “unstable voltage”. An effective display 104e is performed for a candidate action that was effective, from among candidate actions 104b, 104c, and 104d. In FIG. 6, an effective display 104e is performed for the candidate action 104b “replacement of D” for the problematic event 104a “unstable voltage”. When an effect is recorded as a probability value instead of one of two values representing “effective” and “ineffective”, the probability value may be displayed on the effective display 104e.

The candidate actions may be displayed with priorities assigned to, for example, more effective and/or lower-cost candidate actions. For example, FIG. 6 shows an example in which both the effect and the cost are taken into consideration. As shown in FIG. 3, the candidate action 104b “replacement of D” is higher-cost but more effective. On the other hand, the candidate action 104c “replacement of A” and the candidate action 104d “fixation of slackness of Cable C” are lower cost than “replacement of D”, but produce very little effect. Therefore, the processor 101 displays the candidate action 104b at top of the list. Compared to the candidate action 104d, the candidate action 104c is lower-cost and is more effective. Therefore, the processor 101 displays the candidate actions 104c and 104d in this order, subsequent to the candidate action 104b. Weights for determining whether to prioritize effects or costs at the time of display may be either pre-set and fixed, or set by the user.

Also, a plurality of problematic events may be selected for a problematic event designated by the user, as described above. In this case, it is desirable that candidate action sets against a plurality of problematic events be integrated into a single set to be displayed. As an integration method, a method of regarding similar candidate actions as the same candidate action and taking a union of them is conceivable. Besides, it is desirable that the processor 101 determine a display order of candidate actions in consideration of elements such as the effects and costs of the candidate actions including their combination and order, as well as the number of occurrences of similar candidate actions in similar problematic events. The processor 101 may determine a display order based on a confidence score calculated based on a specific calculation formula from these elements, or estimate a display order based on a confidence score calculated by machine learning. As a method of discerning similar candidate actions, a method of taking into consideration synonyms, and a method of evaluating similarity in meaning based on machine learning may be employed, similarly to the search for similar problematic events.

The display of the candidate actions may be performed by an approach other than the approach of simply displaying a list of candidate actions as in FIG. 6.

The processor 101 may display, for example, a hierarchical structure showing a configuration of a device, as shown in FIG. 7, in such a manner that candidate actions are displayed in response to designation by the user in the hierarchical structure. In the example of FIG. 7, a list 104f of device names is displayed, and a list 104g of component names configuring each device is displayed below the list 104f of the device names. The processor 101 may display the list 104g of component names and display candidate actions while illustrating which component an action should be taken against for a designated problematic event on the list 104g. The processor 101 may display candidate actions against the designated problematic event and effectiveness/ineffectiveness when any of the component names displayed on the list 104g is selected.

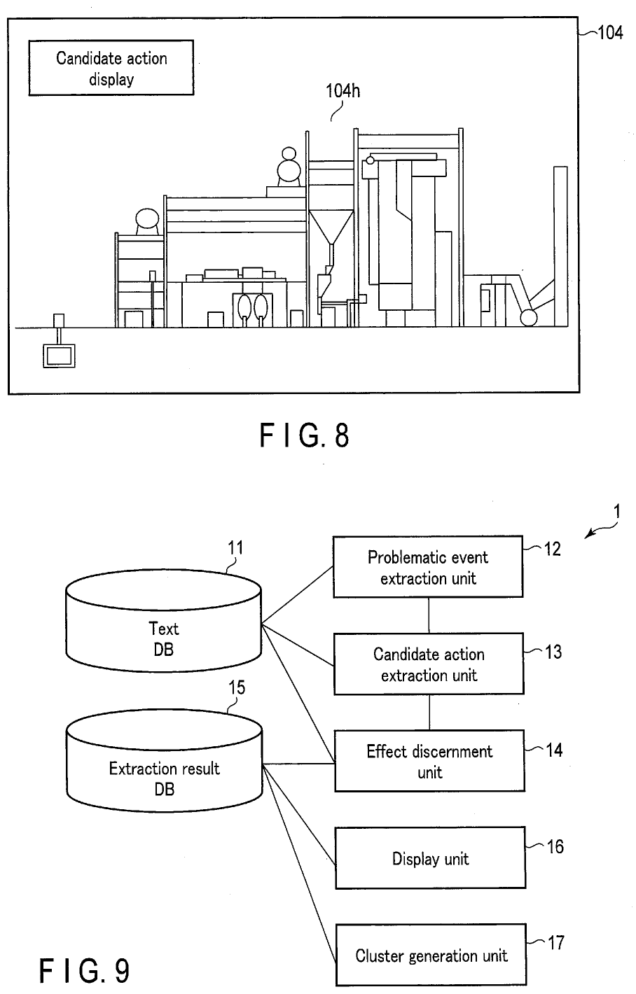

The processor 101 may display a structural diagram 104h of a facility of a device shown in FIG. 8, and display candidate actions for the designated problematic event, while illustrating which portion an action should be taken against in the structural diagram 104h. As a method of displaying candidate actions in this case, a display method in which effectiveness/ineffectiveness is indicated in a portion of a candidate action in the structural diagram 104h, and a display method in which a portion of a candidate action in the structural diagram 104h is colored are conceivable. Moreover, the costs and/or confidence scores may be displayed, in addition to the effects. FIG. 8 is depicted as a structural diagram; however, various diagrams that allow the user to specify a portion of a candidate action, such as a design diagram, may be employed for display.

Referring back to FIG. 5, a further description will be given. At step S11, after displaying candidate actions against the problematic event, the processor 101 evaluates whether to not to end the display. When, for example, an end of the display is instructed by a user operation on the input device 103, it is evaluated that the display is to be ended. When it is evaluated at step S11 that the display is not to be ended, the processing advances to step S12. When it is evaluated at step S11 that the display is to be ended, the processing advances to step S13.

At step S12, the processor 101 evaluates whether or not to change the problematic event. When, for example, a change of the problematic event is instructed by a user operation on the input device 103, it is evaluated that the problematic event is to be changed. When it is evaluated at step S12 that the problematic event is not to be changed, the processing reverts to step S10. In this case, display of the candidate actions against the problematic event is continued. When it is evaluated at step S12 that the problematic event is to be changed, the processing reverts to step S9. In this case, the processor 101 selects a problematic event again.

At step S13, the processor 101 evaluates whether or not to end processing of the information extraction program 1061. When, for example, an end of the processing is instructed by a user operation on the input device 103, it is evaluated that the processing of the information extraction program 1061 is to be ended. When it is evaluated at step S13 that the processing of the information extraction program 1061 is not to be ended, the processing reverts to step S1. When it is evaluated at step S13 that the processing of the information extraction program 1061 is to be ended, the processor 101 ends the processing of FIG. 5.

According to the first embodiment, a problematic event and candidate actions are extracted from text data of a document, as described above. Also, effects of the respective candidate actions against the problematic event are discerned. The problematic event, the candidate actions, and the effects are stored in a database in association with one another. Also, candidate actions and effects associated with a designated problematic event are displayed.

That is, in the first embodiment, effects for problematic events are displayed with respect to not only candidate actions that are effective for a problematic event but also candidate actions that are merely planned to be taken, candidate actions that are yet to be taken but are listed as possible candidate actions. An action listed by a technician, etc. as a candidate action against a problematic event may not be effective as an action against the problematic event, but may be effective as an action against another problematic event. In the embodiment, a user can know not only an action that is effective at that point in time but also an action that is effective at another point in time, and can be expected to take prompt action against a problematic event that has occurred.

### Second Embodiment

Next, a second embodiment will be described. FIG. 9 is a block diagram showing an example of an information extraction apparatus according to a second embodiment. An information extraction apparatus 1 includes a cluster generation unit 17, in addition to a text database (DB) 11, problematic event extraction unit 12, a candidate action extraction unit 13, an effect discernment unit 14, an extraction result database (DB) 15, and a display unit 16.

The cluster generation unit 17 clusters problematic events stored in the extraction result DB 15 in terms of the similarity of candidate action sets. The similarity of candidate action sets may be determined taking into consideration how many similar candidate actions are included, how similar the effects of the respective candidate actions are, how similar combinations or orders of effective candidate actions are, etc. The clustering may be performed by, for example, k-means clustering, hierarchical clustering, etc.

It is assumed, for example, that a plurality of candidate action sets in similar problematic events “current dropping”, “current falling”, and “current dropped” are classified into two clusters. This indicates that two differently oriented candidate actions exist for the same type of problematic events. This is considered to imply that the root causes for the problematic events of the different clusters differ. Through employment of information on the clusters, the processor 101 may display candidate actions of each cluster at the time of presenting candidate actions for similar problematic events, or may add in advance more detailed information to the problematic events of each cluster. When, for example, two clusters are present for the problematic event “current drop”, and the difference between the clusters is “whether or not Function A is working”, the processor 101 may display “current drop during working of Function A” at the time of display of the problematic event.

<Modification>

According to the above-described embodiment, “problematic event”, “candidate action”, and “effect” are associated with one another. On the other hand, a problematic event described in a written report, etc. is considered to require an action to be taken thereagainst, and to correspond to the “purpose” for which the written report is made. Similarly, “candidate action” is considered to correspond to “implementation matter”, which is implemented to accomplish the purpose. Thus, the technique of the embodiment is applicable not only to the case where “problematic event”, “candidate action”, and “effect” extracted from text data of a written report, etc. are stored in a database in association with one another, but also to the case where the “purpose”, “implementation matter”, and “effect” extracted from given text data are stored in a database in association with each other.

Moreover, the instructions included in the process sequences in the above-described embodiments can be implemented based on a software program. A general-purpose computer system may store the program in advance and read the program in order to achieve the same effects as those of the above-described information extraction apparatus. The instruction in the above-described embodiment is recorded, as a computer-executable program, in a recording medium such as a magnetic disk (e.g., a flexible disk, a hard disk, etc.), an optical disk (e.g., CD-ROM, CD-R, CD-RW, DVD-ROM, DVD±R, DVD±RW, and Blu-ray (registered trademark) Disc), a semiconductor memory, or the like. The storage medium may be any storage format that allows a computer or built-in system to perform reading. By reading a program from the recording medium and allowing the CPU to execute an instruction defined in the program based on the program, a computer can realize an operation similar to that of the information extraction apparatus of the above-described embodiment. The computer may, of course, acquire or read the program by way of a network.

In addition, an operating system (OS) working on a computer, database management software, middleware (MW) of a network, etc. may execute a part of the processing to realize the embodiments based on instructions of a program installed from a storage medium onto a computer and a built-in system.

Furthermore, a recording medium in the present embodiment is not limited to a medium independent of a computer or an embedded system, and may be a recording medium that stores or temporarily stores a program transmitted by a LAN or the Internet and downloaded.

Moreover, the number of storage media is not limited to one. The present embodiments include the case where the process is executed by means of a plurality of storage media, and the storage media can take any configuration.

The computer or built-in system in the present embodiments are used to execute each processing in the embodiments, based on a program stored in a storage medium, and the computer or built-in system may be an apparatus consisting of a PC, a microcomputer or the like, or may be a system or the like in which a plurality of apparatuses are connected through a network.

The “computer” in the embodiments is not limited to a PC and encompasses a calculation processing apparatus, a microcomputer, or the like included in an information processor, and is a general term for equipment, a device, an apparatus, etc. capable of allowing a program to realize the functions in the embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information extraction apparatus comprising a processor including hardware configured to:
extract a description of a problematic event from text data;
extract, from the text data, a description of a candidate action for taking an action against the problematic event; and
discern an effect of the candidate action against the problematic event.

2. The information extraction apparatus according to claim 1, further comprising:
a database configured to store the problematic event, the candidate action, and the effect.

3. The information extraction apparatus according to claim 2, wherein
the processor displays a candidate action against a designated problematic event on a display based on the problematic event, the candidate action, and the effect stored in the database.

4. The information extraction apparatus according to claim 3, wherein
the candidate action includes a plurality of candidate actions, and
the processor determines a display order of the candidate actions in accordance with the effect associated with each of the candidate actions.

5. The information extraction apparatus according to claim 3, wherein
the candidate action includes a plurality of candidate actions, and
the processor determines a display order of the candidate actions in accordance with a cost involved in taking each of the candidate actions.

6. The information extraction apparatus according to claim 1, wherein
the processor discerns the effect based on the text data.

7. The information extraction apparatus according to claim 1, wherein
the processor extracts, when the candidate actions are combined to take an action against the problematic event, a combination of the candidate actions as a single candidate action.

8. The information extraction apparatus according to claim 7, wherein
the processor extracts, when the candidate actions are in an order, a combination of the candidate actions including the order as a single candidate action.

9. The information extraction apparatus according to claim 1, wherein
the processor clusters the problematic event based on a similarity of the candidate action.

10. An information extraction method comprising:
extracting a description of a problematic event from text data;
extracting, from the text data, a description of a candidate action for taking an action against the problematic event; and
discerning an effect of the candidate action against the problematic event.

11. A computer-readable, non-transitory recording medium recording thereon an information extraction program for causing a computer to:
extract a description of a problematic event from text data;
extract, from the text data, a description of a candidate action for taking an action against the problematic event; and
discern an effect of the candidate action against the problematic event.
